(19) United States
(12) Patent Application Publication
(10) Pub. No.: US 2019/0101404 A1
(43) Pub. Date: Apr. 4, 2019

(54) INFORMATION PROCESSING METHOD AND ELECTRONIC DEVICE

(71) Applicant: Lenovo (Beijing) Co., Ltd., Beijing (CN)

(72) Inventor: Shuxian ZHANG, Beijing (CN)

(21) Appl. No.: 16/148,065

(22) Filed: Oct. 1, 2018

(30) Foreign Application Priority Data
Sep. 29, 2017 (CN) 201710909266.1

(51) Int. Cl. G01C 21/34; G08G 1/01; G01C 21/20

(52) U.S. Cl. CPC G01C 21/3492; G01C 21/3461; G01C 21/20; G08G 1/0129

(57) ABSTRACT

A navigation method from a first location to a second location includes predicting traffic condition between the first and second locations at a future time using historical traffic condition information between the first and second locations and, according to the predicted traffic condition between the first and second locations, providing a navigation route from the first location to the second location.

### CROSS-REFERENCE TO RELATED APPLICATION

This application claims priority to Chinese Patent Application No. 201710909266.1, filed on Sep. 29, 2017, the entire contents of which are incorporated herein by reference.

### FIELD OF THE DISCLOSURE

The present disclosure generally relates to the field of electronic technology and, more particularly, to an information processing method and an electronic device.

### BACKGROUND

With the development of science and technology, electronic technology has also developed rapidly. There are more and more types of electronic products available. People have also enjoyed the convenience brought about by the development of science and technology. Nowadays, people can enjoy comfortable life with the development of science and technology through using various types of electronic devices.

In existing technologies, navigational electronic devices have been widely applied. While people enjoy the convenience brought about by these navigational electronic devices, they are also facing an unavoidable problem. That is, currently most of online navigation applications have an option to avoid congestion when planning a navigation route, such that congested points can be avoided by planning routes according to current congestion conditions of road-segment traffic. Traditional technologies detect the congested road segments in real-time, however, the congested road segments are actually varying with the time. For example, after a vehicle is driven according to the navigation route and arrives at a position, a previously congested road segment may have been clear, while a previously clear road segment may have been congested. Hence, according to this manner of route planning, sometimes traffic congestion cannot be effectively avoided.

The disclosed information processing method and apparatus thereof are directed to solve one or more problems set forth above and other problems.

### BRIEF SUMMARY OF THE DISCLOSURE

One aspect of the present disclosure provides a navigation method from a first location to a second location including predicting traffic condition between the first and second locations at a future time using historical traffic condition information between the first and second locations and, according to the predicted traffic condition between the first and second locations, providing a navigation route from the first location to the second location.

Another aspect of the present disclosure provides a navigation device including a processor, an input device coupled to the processor, and a display unit coupled to the processor. The input device is configured to input a new location. The display unit is configured to display a navigation route from a first location to the new location. The processor is configured to predict traffic condition between the first location and the new location at a future time using historical traffic condition information between the first location and the new location, and to instruct the display unit to display the navigation route from the first location to the new location according to the predicted traffic condition between the first location and the new location.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of an information processing method consistent with disclosed embodiments; and

FIG. 2 illustrates a schematic block diagram of a navigation device consistent with disclosed embodiments.

### DETAILED DESCRIPTION

To make those skilled in the art better understand the technical solutions of the present disclosure, embodiments of the present disclosure will be described in detail with reference to the accompanying drawings. Also, various aspects and features of the present disclosure are described herein with reference to the accompanying drawings.

These and other features of the present disclosure will become apparent from the following description of the disclosed embodiments given as non-limiting examples with reference to the accompanying drawings. It should also be understood that although the present disclosure has been described with reference to certain specific examples, those skilled in the art can certainly implement many other equivalent forms of the present disclosure having the features recited in the claims. Therefore, these equivalent forms of the present disclosure also fall within the scope of this protection.

Hereafter, specific embodiments of the present disclosure will be described with reference to the accompanying drawings; however, it should be understood that the disclosed embodiments are merely examples of the present disclosure and can be implemented in various manners. Well-known and/or repetitive functions and structures have not been described in detail to avoid unnecessary or superfluous details that would obscure the present disclosure. Hence, the specific structural and functional details disclosed herein are not intended to be limiting, but merely serve as a basis and a representative basis of the claims for instructing those skilled in the art to variously employ the present disclosure in literally any appropriate detailed structure.

This description may use the phrases “in one embodiment”, “in another embodiment”, “in yet another embodiment”, or “in other embodiments”, which may refer to one or more of the same or different embodiments in accordance with the present disclosure.

The present disclosure provides an information processing method for application in electronic devices. The method may include: predicting traffic-condition information about a location at a future time according to data; and acquiring a suggested navigation route to avoid a congested road segment at the future time according to the predicted information of congested road segment(s) at the future time.

As can be seen from the above description, the above information processing method may achieve that, after people use the navigational electronic devices, the traffic-condition information about the location at the future time can be predicted according to the data, and the suggested navigation route can be acquired to avoid the road segment(s) of the location at the future time according to the predicted information of congested road segment(s) at the future time.

To better understand the above technical solutions, the working principle of the above-mentioned navigation device will be described in detail below in conjunction with the accompanying drawings and the implementation manners.

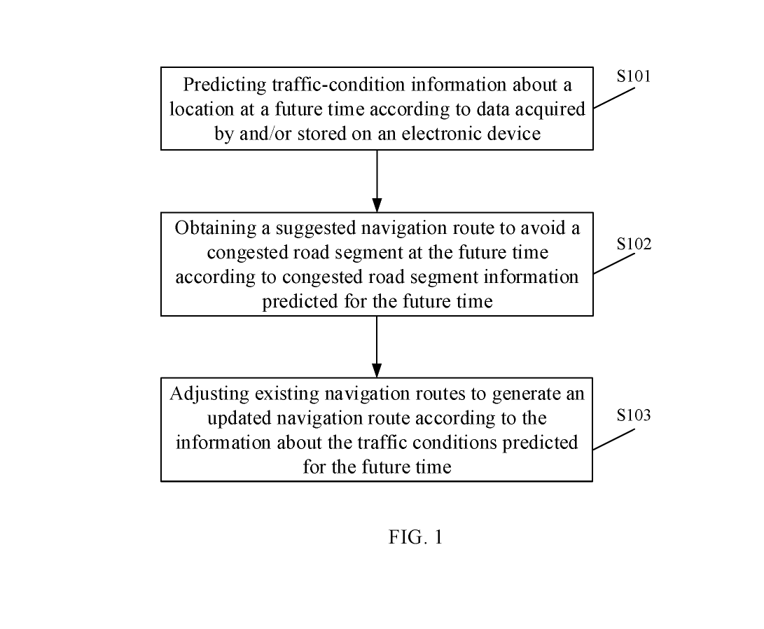

FIG. 1 illustrates a flow chart of an information processing method consistent with disclosed embodiments. The information processing method can be, for example, a navigation method from a first location to a second location. As shown in FIG. 1, an information processing method consistent with the present disclosure is applied to an electronic device. The electronic device may include a mobile phone, a navigator, or an in-vehicle computer, etc. The method may comprise steps as described in the followings.

As shown in FIG. 1, first, in Step S101, according to data acquired by and/or stored on the electronic device, traffic-condition information is predicted about a location at a future time.

In one embodiment, the data may include historical records of traffic conditions, also referred to as historical traffic condition information. The user may move from one location (e.g., the “first location”) to a destination (e.g., the “second location,” also referred to as a “new location”), and the historical traffic condition information can include historical traffic condition information between the first and second locations. As the user continuously moves toward the destination, the data or relevant information about the traffic conditions of the destination or the traffic conditions of a location between the user and the destination may also be included as part of the data, which can be used to predict the traffic conditions of locations at the future time. That is, as the user continuously moves toward the destination, the data may be updated in real-time to meet requirements of actual usage. In addition, the data may also include the speed at which the user travels to the destination and, together with the distance of the user away from the destination, it can be calculated when the user can reach the destination. The traffic-condition information about the destination, e.g., the traffic condition between the first location and the second location, can also be predicted at a calculated time when the user arrives at the destination, such that when the user arrives at the destination, traffic flow at the destination can be ensured to remain smooth. Meanwhile, the information of traffic conditions may include congested-road-segment information and clear-road-segment information. The congested-road-segment information may include information about the road segment(s) that is(are) congested or where traffic flow is not smooth, while the clear-road-segment information may include information about the road segment(s) with smooth traffic flow.

In the followings, a navigation device will be illustrated as an example of the electronic device.

In one embodiment, after the user decides to drive a vehicle from location A to location B, the user may set the location B as the destination via the navigation device. The navigation device may immediately start to perform analysis according to the destination information inputted by the user. The navigation device can retrieve the historical records of traffic conditions for each route from location A to location B, i.e., the historical traffic condition information between location A and location B. While the user is driving the vehicle to the location B, since the navigation device is connected to a network, the navigation device can acquire in real-time traffic-condition information about the location B or information related to the traffic-condition information about the location B. Further, the navigation device can obtain the traffic-condition information about the locations between the user and the destination (i.e., the location B) or information related to the traffic-condition information, thus allowing the user to acquire information about travel routes and real-time usage and making the driving smoother. Meanwhile, according to the speed at which the user drives the vehicle and the distance of the user away from the destination, the navigation device may calculate when the user can reach the destination (i.e., the location B) and may predict the traffic-condition information about the location B at the calculated time when the user arrives at the destination (i.e., the location B).

Further, in Step S102, according to the predicted congested-road-segment information at the future time, a suggested navigation route is obtained to avoid the congested road segment(s) at the future time. The suggested navigation route may include one or more navigation paths for the user to choose. That is, a navigation route from the first location to the second location can be provided according to the predicted traffic condition between the first and second locations.

The navigation device is illustrated again as an example of the electronic device. In one embodiment, according to the predicted congested-road-segment information of the traffic-condition information at the future time, the navigation device may provide one or more preferred navigation paths for the user to choose. For example, the navigation paths may be one or more of the shortest path in time, the path with the least traffic lights, or the smoothest path, etc. Thus, the user can make selections according to actual needs and can avoid the congested road segment(s) at the future time.

In one embodiment, according to the predicted congested-road-segment information at the future time, the suggested navigation route may be obtained. It may also be in accordance with the predicted traffic-condition information at the future time and the distance away from the location. By predicting whether the location will be congested or not after the vehicle arrives at the location at the future time, the suggested navigation route may be obtained.

In one embodiment, the predicted traffic-condition information at the future time may include the traffic-condition information between the user and the destination. For example, at 4:30 p.m., the traffic-condition information of the destination or the traffic-condition information of another location C being passed through the selected route may be predicted in the time period from 4:30 p.m. to 6:30 p.m. Meanwhile, the information processing method in the present disclosure may also calculate the distance of the user away from the destination. And according to the current speed at which the user is travelling, it may be calculated when the user will reach the destination at the current speed and it may be predicted whether the destination will be congested or not after the user arrives at the destination, such that the suggested navigation route can be obtained.

The navigation device is illustrated again below as an example of the electronic device. For example, at 4:30 p.m., the navigation device may predict the traffic-condition information of the destination (i.e., the location B), or the traffic-condition information of location C being passed through in the selected route in the time period from 4:30 p.m. to 6:30 p.m. However, the navigation device may predict that location C will be congested in the time period from 5:30 p.m. to 6:30 p.m. At the current time, the distance from the location C is 50 km and the user's speed is currently 50 km/h and, that is, the user will catch up with the traffic congestion after the user arrives at the location C. In one embodiment, at this point, the navigation device may provide the predicted traffic-condition information to the user, and according to the obtained traffic-condition information the navigation device may in the meantime suggest the navigation route for the user. For example, another new route may be provided to the user, or it may be suggested that the user can appropriately increase the speed to, e.g., 60 km/h or 70 km/h. As such, the user can reach and pass the location C smoothly before congestion occurs in the location C. After the user increases the vehicle speed, speed limit mark in the road segment(s) and actual speed of the vehicle may be combined, such that the congested road segment(s) can be smoothly avoided and the driving safety can be ensured for the user. After the above suggestion is given, the navigation device may also acquire the traffic-condition information of the road segment(s) between the user and the destination in real-time.

According to the predicted congested-road-segment information at the future time, the suggested navigation route may be obtained. In one embodiment, the prediction of the traffic-condition information of the location during different time periods in the future may also be in accordance with an analysis of historical data of traffic conditions.

In one embodiment, the historical data of traffic conditions may include the historical data of traffic conditions of each road segment between the user's location and the destination, and the historical data of traffic conditions of each location that needs to pass through from the user's location to the destination. For example, there is a road segment D between the user's location and the destination. According to records of the historical data of traffic conditions, congestion occurs at the road segment D every day in the time periods from 8:00 a.m. to 9:00 a.m. and from 5:00 p.m. to 6:00 p.m. If the user travels in these time periods, the road segment D may be avoided from the suggested navigation route.

The navigation device is illustrated again below as an example of the electronic device. For example, at 4:40 p.m., the user needs to drive from location A to location B (i.e., the destination), which may take about 2 hours. There is a navigation route that needs to pass through the road segment D from the navigation routes generated by the navigation device. According to the record of the historical data of traffic conditions, congestion occurs at the road segment D every day in the time periods from 8:00 a.m. to 9:00 a.m. and from 5:00 p.m. to 6:00 p.m. During the travel from location A to location B (i.e., the destination), the user will pass through the road segment D in the very time period between 5:00 p.m. and 6:00 p.m. In one embodiment, at the point after the navigation device provides the suggested route, the navigation device may display a corresponding prompt coupled to the suggested route that includes the above road segment D according to the record of the historical data of traffic conditions. For example, the prompt may be: “road segment D will experience congestion from 5:00 p.m. to 6:00 p.m., it is recommended to choose other suggested routes or other relevant prompts”.

In one embodiment, according to the predicted congested-road-segment information at the future time, the suggested navigation route may be obtained, and first information may also be obtained. The first information may include information about the future time. According to the first information, the traffic-condition information may be predicted at the future time.

The first information may include one or more of future weather conditions, future road segments under traffic control, or events that will take place and have a potential impact on traffic conditions in future locations. For example, the user plans to go to a location and sets a navigation route in advance to prepare for the travel. Between the user and the destination there is a road segment D that belongs to the navigation route and is passed through. During passing through the road segment D by the user, traffic control may be just implemented on the road segment D. In one embodiment, at this point after the first information is obtained, the information processing method consistent with the disclosure may feedback this information to the user and may suggest other appropriate navigation routes for the user.

The navigation device is illustrated again below as an example of the electronic device. For example, currently on August 31st, the user intends to go to a location on September 1st and makes appropriate preparations in advance to ensure that the route will be smooth. Hence, the user uses the navigation device for navigation. There is a road segment D that belongs to a navigation route and needs to pass through, and there are a couple of schools on the road segment D. On September 1st, these schools will be open and this event will inevitably affect the traffic conditions of road segment D. In one embodiment, at this point, the navigation device may prompt a message coupled with the corresponding navigation route to inform the user about that the road segment D will be congested when the user passes through it on September 1st, and in the meantime may prompt the user to select other navigation routes for travel, thereby ensuring that the user will travel smoothly.

After the navigation route is recommended to the user, the information processing method consistent with the present disclosure may further comprise a step (S103) of adjusting the existing navigation route(s) to generate an updated navigation route according to the predicted traffic-condition information at the future time.

In one embodiment, the predicted traffic-condition information at the future time may include the traffic-condition information during the period of time when the user is on the route travelling to the destination or arriving at the destination.

The navigation device is illustrated again below as an example of the electronic device. For example, while the user travels along the suggested navigation route, at a distance from the location E, the navigation device acquires data indicating that there are a large number of vehicles driving into the location E. In this case, after the user travels to the location E, the user will be blocked due to the large number of incoming vehicles. In one embodiment, at this point, according to the prediction, the navigation device may beforehand provide a prompt that congestion will occur at the location E, and may adjust the navigation route currently being used and may generate a new navigation route that can allow the user to smoothly arrive at the destination.

The electronic device disclosed in the embodiments of the present disclosure is not limited to the above navigation device, and may also include a mobile phone, an in-vehicle computer, etc., which are not described in detail herein.

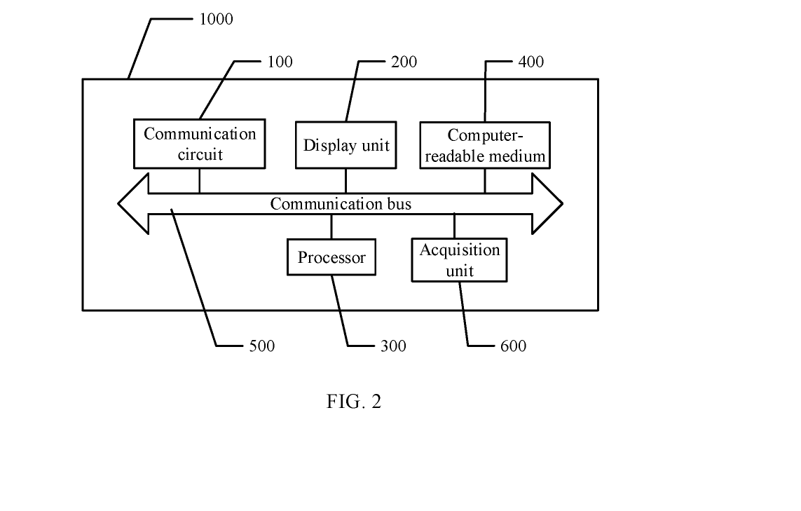

In addition to the disclosed information processing method, the present disclosure also provides a navigation device. FIG. 2 illustrates a schematic block diagram of a navigation device consistent with disclosed embodiments.

As shown in FIG. 2, the navigation device 1000 may include a communication circuit 100, a display unit 200, a processor 300, a computer-readable medium 400, a communication bus 500, and an acquisition unit 600. Other appropriate components may also be included.

The communication circuit 100, the display unit 200, the processor 300, the computer-readable medium 400, and the acquisition unit 600 may be connected through the communication bus 500. The processor 300 may also control the display unit 200 to output the display data.

The computer-readable medium 400 may store computer programs, and data generated during the operation of the processor 300. The computer-readable medium 400 may include ROM, RAM, flash memory, and mass storages, such as CD-ROM and hard disk, etc. The processor 300 may include any appropriate processor or processors. Further, the processor 300 may include multiple cores for multi-thread or parallel processing. The display unit 200 may display the data, such as a navigation route from the first location to the new location, under the control of the processor 300.

The processor 300 can be configured to perform a method consistent with the disclosure, such as one of the above-described example methods. In one embodiment, according to data, the processor 300 may be configured for predicting the traffic-condition information about a location at a future time. And according to the predicted congested-road-segment information at the future time, the processor 300 may be configured for obtaining a suggested navigation route to avoid the congested road segment(s) at the future time.

In one embodiment, the processor 300 may be installed on the side of the navigation device 1000, or may be configured on the side of a server enclosure. In actual use, the processor 300 may be freely coupled to any side, as long as it is convenient for use and can meet usage requirements.

Further, the processor 300 may be configured for obtaining the suggested navigation route according to the predicted congested-road-segment information at the future time. The details are described below.

According to the predicted traffic-condition information at the future time as well as the distance away from the location, whether the location will be congested or not after arrival at the location may be predicted in the future to obtain a suggested navigation route.

Further, in one embodiment, according to the predicted traffic-condition information at the future time, the prediction of the traffic-condition information during different time periods in the future may be in accordance with an analysis of historical data of traffic conditions.

Further, as shown in FIG. 2, the navigation device 1000 may include the acquisition unit 600 for obtaining first information. The first information is the information about the future time.

According to the predicted traffic-condition information at the future time, the prediction of the traffic-condition information at the future time may be in accordance with the first information.

In some embodiments, the navigation device 1000 may further include an input device coupled to the processor 300, e.g., through the communication bus 500, and configured to receive an input of the new location.

The navigation device described in the embodiments of the present disclosure is the device used in the information processing method consistent with the disclosure. Therefore, according to the information processing method consistent with the disclosure, those skilled in the art should understand the implementation manners of the electronic device in the disclosed embodiments as well as various forms of changes. Hence, the detailed description of this device is omitted here. The devices implemented by those skilled in the art according to the information processing method consistent with the disclosure would belong to the scope of protection of the present disclosure.

Those skilled in the art should understand that the embodiments of the present disclosure can be provided as a method, a system or a computer program product. Therefore, the present disclosure can be in the form of complete hardware embodiment, complete software embodiment or hardware and software combined embodiment. Moreover, the present disclosure can be in the form of a computer program product implemented on one or more computer-readable media (including, but not limited to, disk memory, CD-ROM and optical memory), which may comprise computer-usable program codes.

The present disclosure is described with reference to the flowchart and/or block diagram of the method, device (system) and computer program product according to the embodiments thereof. It should be understood that every flow and/or block in the flowchart and/or block diagram, and the combination of flow and/or block in the flowchart and/or block diagram can be implemented by the computer program instructions. Such computer program instructions can be provided to processors of a general computer, a dedicated computer, an embedded processing unit or other programmable data processing devices to produce a machine, such that the processor of the computer or other programmable data processing devices can execute the instructions to produce a device used for implementing the functions specified in one or more flows in the flowchart and/or one or more blocks in the block diagram.

These computer program instructions can also be stored in a computer-readable medium capable of booting the computer or other programmable data processing devices to function in specified modes, such that the instructions stored in the computer readable memories can generate a product having an instruction device which implements the functions specified in one or more flows in the flowchart and/or one or more blocks in the block diagram.

These computer program instructions can also be loaded in the computer or other programmable data processing devices for executing a series of operation steps thereon to generate a process implemented by the computer, such that the instructions executed on the computer or other programmable data processing devices can provide the procedures for implementing the functions specified in one or more flows in the flowchart and/or one or more blocks in the block diagram.

The above embodiments are merely exemplary embodiments of the present disclosure and are not intended to limit the present disclosure. The protection scope of the present disclosure is defined by the claims. Those skilled in the art can make various modifications or equivalents to the present disclosure within the spirit of the present disclosure and the protection scope, and such modifications or equivalent replacements should also be regarded as falling within the protection scope of the present disclosure.

What is claimed is:

1. A navigation method from a first location to a second location, comprising:
predicting traffic condition between the first and second locations at a future time using historical traffic condition information between the first and second locations; and
according to the predicted traffic condition between the first and second locations, providing a navigation route from the first location to the second location.

2. The method according to claim 1, wherein providing the navigation route includes:
according to the predicted traffic condition at the future time and a distance between the first and second locations, predicting whether the second location will be congested at the future time; and
providing the navigation route according to whether the second location will be congested.

3. The method according to claim 1, wherein predicting the traffic condition at the future time includes:
according to an analysis of the historical traffic condition information, predicting the traffic condition during different time periods in future.

4. The method according to claim 1, wherein predicting the traffic condition at the future time includes:
acquiring first information, wherein the first information is information about the future time; and
according to the first information, predicting the traffic condition at the future time.

5. The method according to claim 4, wherein the first information includes:
one or more of a future weather condition, a future road segment under traffic control, and an event that will take place and have a potential impact on the traffic condition at the second location.

6. The method according to claim 1, further comprising:
according to the predicted traffic condition, adjusting an existing navigation route to generate an updated navigation route.

7. A navigation device, comprising:
a processor;
an input device coupled to the processor, the input device being configured to input a new location; and
a display unit coupled to the processor, the display unit being configured to display a navigation route from a first location to the new location;
wherein the processor is configured to predict traffic condition between the first location and the new location at a future time using historical traffic condition information between the first location and the new location, and to instruct the display unit to display the navigation route from the first location to the new location according to the predicted traffic condition between the first location and the new location.

8. The device according to claim 7, wherein the processor is further configured to:
according to the traffic condition at the future time and a distance between the first location and the new location, predict whether the new location will be congested at the future time; and
instruct the display unit to display the navigation route provided according to whether the new location will be congested.

9. The device according to claim 7, wherein the processor is further configured to:
according to an analysis of the historical traffic condition information, predict the traffic condition during different time periods in future.

10. The device according to claim 7, wherein the processor is further configured to:
acquire first information, wherein the first information is information about the future time; and
according to the first information, predict the traffic condition at the future time.

11. The device according to claim 10, wherein the first information includes:
one or more of a future weather condition, a future road segment under traffic control, and an event that will take place and have a potential impact on the traffic condition at the new location.

12. The device according to claim 7, wherein the processor is further configured to:
according to the predicted traffic condition, adjust an existing navigation route to generate an updated navigation route.
